(19) United States
(12) Patent Application Publication
(10) Pub. No.: US 2006/0270282 A1
(43) Pub. Date: Nov. 30, 2006

(54) Bulb socket for light string

(76) Inventor: Yuan Hui Tsai, Nantou (TW)

Correspondence Address: BACON & THOMAS, PLLC, 625 SLATERS LANE, FOURTH FLOOR, ALEXANDRIA, VA, 22314, US

(21) Appl. No.: 11/139,642

(22) Filed: May 31, 2005

(51) Int. Cl. H01R 33/22

(52) U.S. Cl. 439/666

(57) ABSTRACT

Disclosed is a bulb socket for use in a light string including electrical wires that supply power to the bulb socket and dummy wires that fix the electrical wires together. The bulb socket includes a dummy wire retainer that is formed on an outside surface of a body of the socket. A through hole and a blind hole are defined in the retainer. A loose end of a dummy wire is allowed to extend through the through hole. The loose end of the dummy wire, after extending through the through hole, is bent to fit into and is thus concealed inside the blind hole.

### BACKGROUND OF THE INVENTION

1. Field of the Invention

The present invention relates generally to light strings for decorations for holidays and festivals, such as Christmas light strings, and in particular to a bulb socket of the light string that forms a dummy wire retainer to retain and hide loose ends of dummy wires of the light string.

2. The Related Art

Light strings are a commonly used measure of decorations in holidays and festivals. An example is a Christmas light string that is often fixed to for example windows or Christmas trees. Some of the light strings are made circular, of which electrical wires along which a plurality of bulb sockets that receive and retain light bulbs is distributed is bent to form a large ring. The ring-shaped light string comprises dummy wires that fix the electrical wires that serve to supply power to the light bulbs together.

FIG. 1A of the attached drawings shows a portion of the conventional ring-shaped light string, for illustration of the dummy wires, which are designated with reference numeral 13A, that fix the electrical wires 11A, 12A that supply power to bulb sockets 1A together. FIG. 1 particularly illustrates the conventional bulb socket 1A. The dummy wires have loose ends, which are often knotted together in the conventional arrangement. Such loose ends, due to not being properly arranged, are often mistakenly though as broken wires, causing panic to the generally consumers who unexpectedly glances over the loose ends. In addition, such loose ends of the dummy wires deteriorate the aesthetic appearance of the light string.

Thus, it is desired to have an improved light string comprising bulb socket forming dummy wire retainer to properly hiding and fixing the loose ends of the dummy wires so as to overcome the problems discussed above.

### SUMMARY OF THE INVENTION

An objective of the present invention is to provide a bulb socket for light string, which bulb socket forms a dummy wire retainer for properly fixing a loose end of a dummy wire.

Another objective of the present invention is to provide a bulb socket for light string, which bulb socket forms a dummy wire retainer that receives and conceals a loose end of a dummy wire.

A further objective of the present invention is to provide a decorative light string wherein loose ends of dummy wires of the light string are received, fixed and concealed in dummy wire retainers formed in bulb sockets of the light string to as to aesthetically improve the light string.

To realize the above objectives, in accordance with the present invention, there is provided a bulb socket for use in a light string comprising electrical wires that supply power to the bulb socket and dummy wires that fix the electrical wires together. The bulb socket comprises a dummy wire retainer that is formed on an outside surface of a body of the socket. A through hole and a blind hole are defined in the retainer. A loose end of a dummy wire is allowed to extend through the through hole. The loose end of the dummy wire, after extending through the through hole, is bent to fit into and is thus concealed inside the blind hole.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conventional bulb socket for use in a light string;

FIG. 1A is a perspective view illustrating a portion of a light string in which the bulb socket of FIG. 1 is incorporated;

FIG. 2 is a perspective view of a bulb socket constructed in accordance with the present invention, wherein a dummy wire retainer comprised of a through hole and a blind hole is formed in the bulb socket;

FIG. 3 is a cross-sectional view of the dummy wire retainer of the present invention, with a body of the bulb socket shown with phantom lines;

FIG. 4 is a side elevational view of the bulb socket with the dummy wire retainer shown in section;

FIG. 5 is a top plain view of the bulb socket of the present invention;

FIG. 6 is a side elevational view illustrating an application of the bulb socket that is mounted to a light string comprised of electrical wires and dummy wires;

FIG. 7 is a perspective view of the light string in which the bulb socket of the present invention is incorporated; and

FIG. 8 is a perspective view showing a bulb socket constructed in accordance with another embodiment of the present invention.

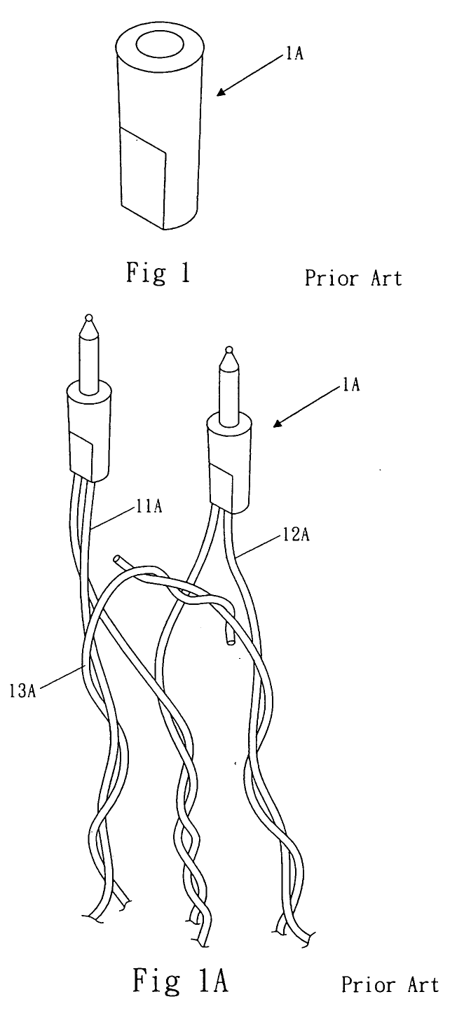

### DETAILED DESCRIPTION OF THE PREFERRED EMBODIMENTS

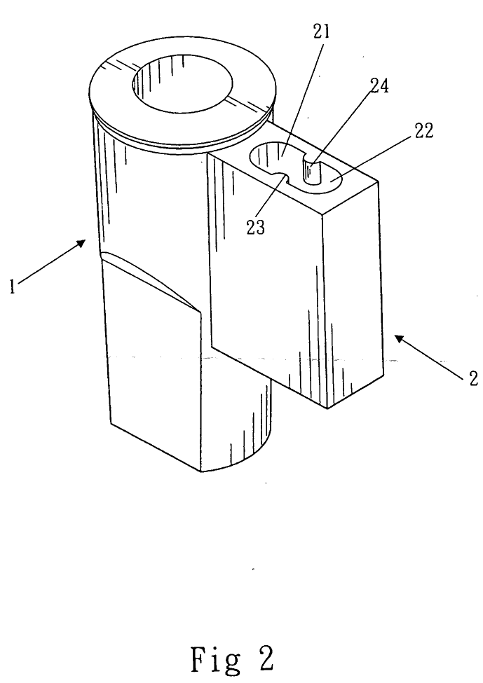

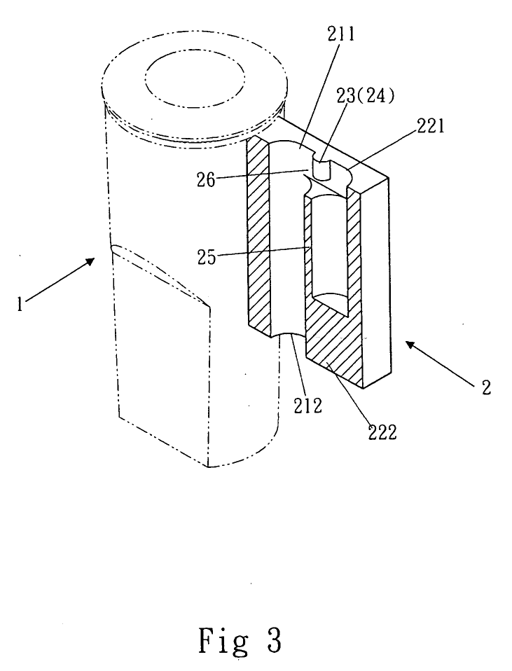

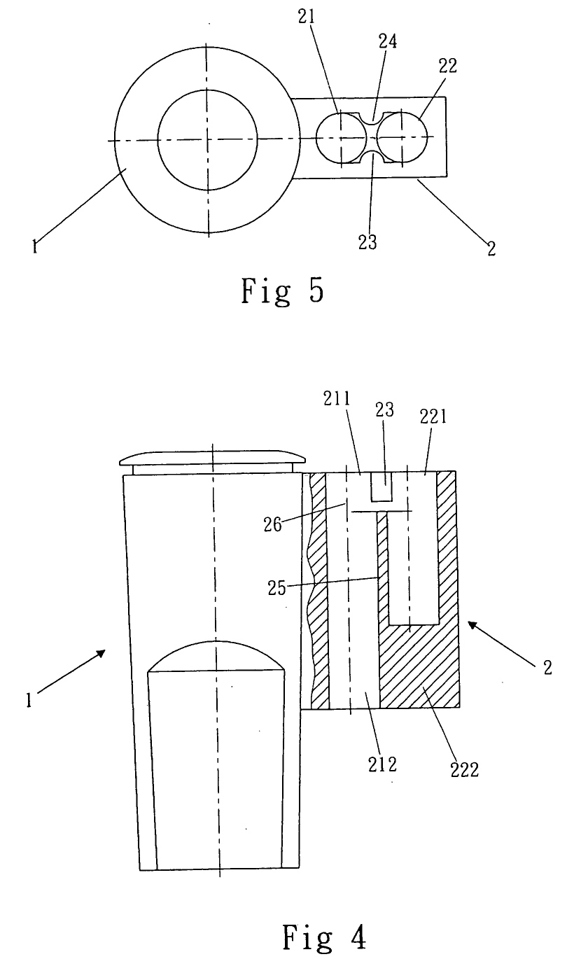

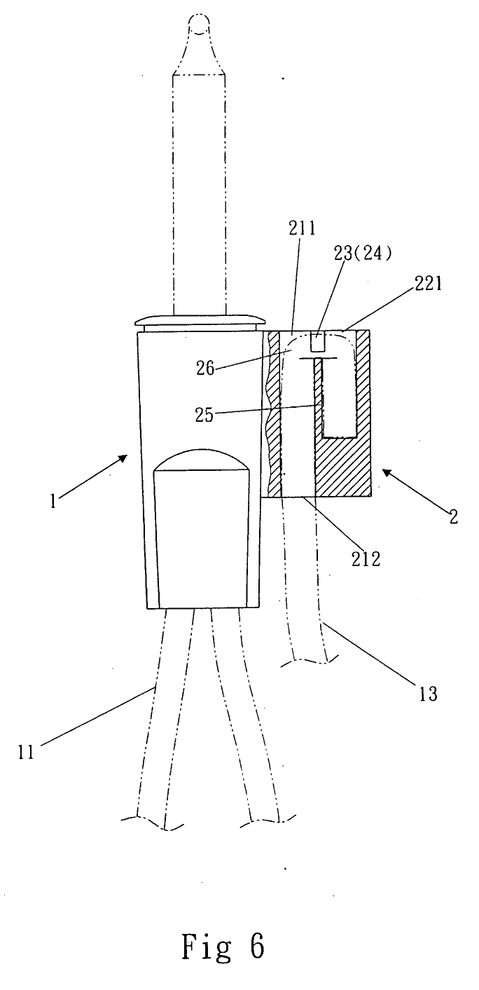

With reference to the drawings and in particular to FIGS. 2-5, a bulb socket constructed in accordance with the present invention comprises a socket body 1, made of insulation material, which is of a conventional cylindrical configuration in which a bore (not labeled) is defined to receive and retain a light bulb (see phantom lines of FIG. 6). Conductors (not shown) are embedded in the insulation body for electrical connection with the light bulb received in the bore.

A dummy wire retainer, which is generally designated with reference numeral 2, is mounted, either in a removable manner or a fixed manner, to or integrally formed with the socket body 1. The dummy wire retainer 2 is formed on an outside surface of the cylindrical socket body 1. The dummy wire retainer 2 forms two holes 21, 22 extending in directions substantially parallel to axial direction of the bore of the socket body 1. However, it is apparent to those having ordinary skills to arrange the dummy wire retainer 2 at different locations and different orientations with respect to the socket body 1. Further, there is no limitation to the outer shape of the retainer 2. In other words, the retainer 2 can be of any desired shape, provided the holes 21, 22 can be defined inside such shaped retainer.

The first hole 21 is a through hole defining a top opening 211 and a bottom opening 212, while the second hole 22 is a blind hole having a top opening 221 but a closed bottom 222. The first and second holes 21, 22 are separated from each other by a partition 25 between and co-extensive with the holes 21, 22, except at a top end section in which the first and second holes 21, 22 are in communication with each other by a passage 26 extending through the partition 25. Opposite projections 23, 24 are formed on opposite side walls of the passage 26 to define a neck of the passage 26.

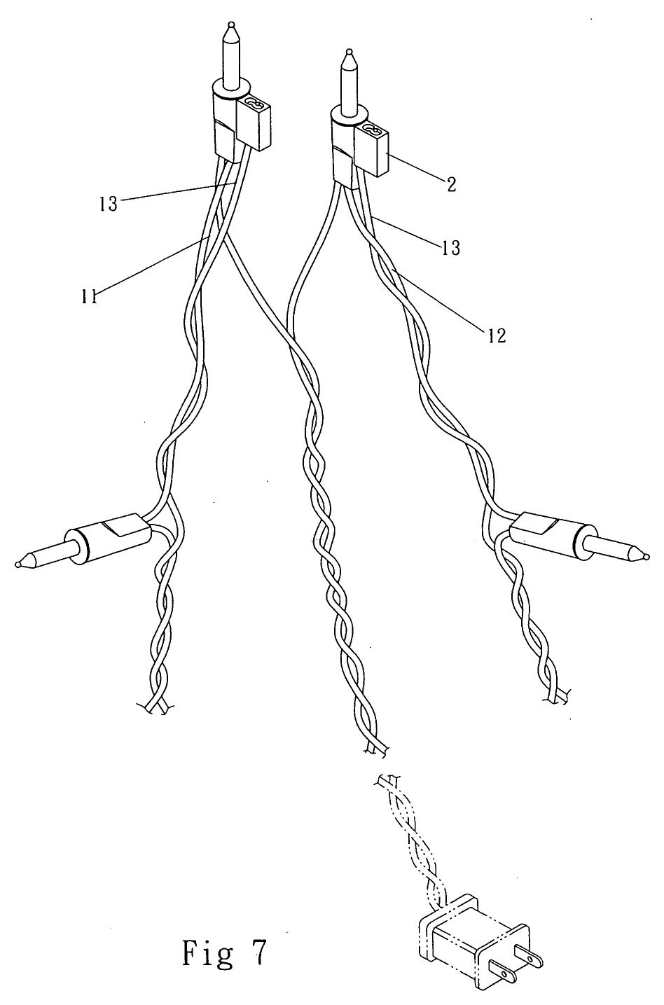

Also referring to FIGS. 6 and 7, a light string that incorporates a number of bulb sockets 1 of the present invention comprises electrical wires 11, 12 that are mechanically and electrically connected to the conductors inside the bulb sockets 1 and dummy wires 13 that fix the electrical wires 11, 12 together. Each dummy wire 13 has a loose end section. To fix and conceal the loose end of the dummy wire 13, the end section of the dummy wires 13 is inserted through the through hole 21 of an associated bulb socket 1, from the bottom opening 212 to the top opening 211, and, after the insertion through the through hole 21, the end section is bent over and fit into the blind hole 22 through the top opening 221 whereby the loose end of the dummy wire 13 is fixed and concealed in the blind hole 22.

The bent portion of the end section of the dummy wire 13 extends through the passage 26 between the through hole 21 and the blind hole 22. The neck of the passage 26 that is delimited by the projections 23, 24 serves to secure the loose end of the dummy wire 13 in the dummy wire retainer 2 by causing inward deformation or partial compression of the bent portion of the end section of the dummy wire 13 by the projections 23, 24.

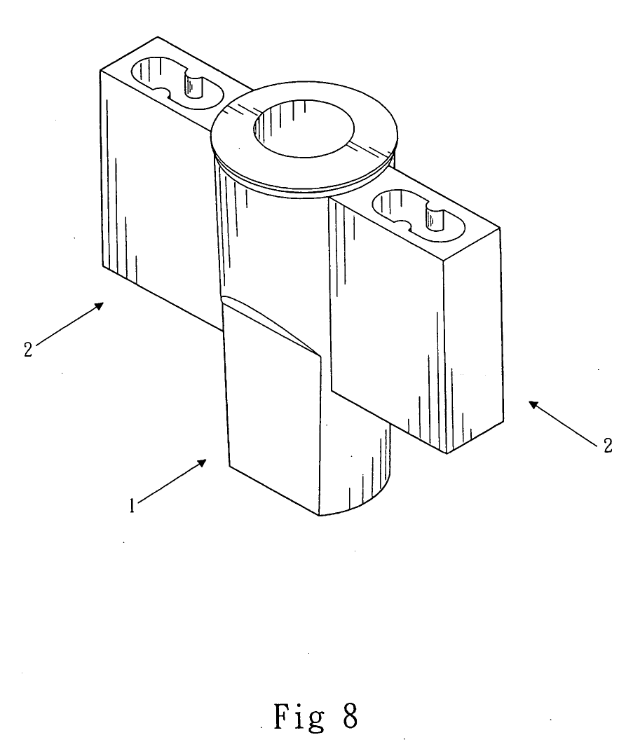

Although in the embodiment illustrated in FIGS. 2-7, only one dummy wire retainer is formed in each bulb socket, it is apparent to those having ordinary skills to add more such wire retainer to the bulb socket. An example is shown in FIG. 8, in which two dummy wire retainers 2 are formed on opposite sides of the socket body 1 of the bulb socket. The two dummy wire retainers 2 are of exactly the same construction as that shown in FIGS. 2-7, and thus further description is not necessary.

The bulb socket of the present invention offers at least the following advantages:

(1) The dummy wire retainer can be integrally formed with the socket body, which is not only simple in structure, but also low cost. Concealing the loose end of the dummy wire enhances the operation efficiency and consumers' confidence of purchase and use of the light string.

(2) The number of the dummy wire retainer can be changed in accordance with the number of the dummy wires employed in a light string and the number of the dummy wire retainers is not limited, unless there is no space on the socket body to accommodate them.

(3) Further, the bulb socket of the present invention can be employed in both a ring-shaped light string and light string of other shapes or configurations. There is no restriction for the application of the bulb socket of the present invention in light string of different configurations and shapes.

Although the present invention has been described with reference to the preferred embodiments with reference to the drawings thereof, it is apparent to those skilled in the art that a variety of modifications and changes may be made without departing from the scope of the present invention which is intended to be defined by the appended claims.

What is claimed is:

1. A bulb socket, comprising:
a socket body having an outer surface; and
a retaining device comprising at least one retainer mounted to the outside surface of the socket body, the retainer defining a first through hole and a second blind hole, the first hole having a top opening and a bottom opening, the second hole having a top opening and a closed bottom, a partition arranged between and co-extending with the first and second holes with a passage transversely extending through the partition and communicating top openings of the first and second holes, opposite projections being formed on opposite side walls of the passage.

2. The bulb socket as claimed in claim 1, wherein the retainer is separable from the socket body.

3. The bulb socket as claimed in claim 1, wherein the retainer is of any desired shape.

4. The bulb socket as claimed in claim 1, which is adapted in both a ring-shaped light string and light strings of other configurations.
